(19) United States
(12) Patent Application Publication
(10) Pub. No.: US 2026/0260309 A1
(43) Pub. Date: Sep. 3, 2026

(54) SMART ASYNCHRONOUS TIME WARP BOOST MANAGER FOR EXTENDED REALITY

(71) Applicant: QUALCOMM Incorporated, San Diego, CA (US)

(72) Inventors: Karthik RANGARAJU, San Diego, CA (US); Pankaj GUPTA, Jhalawar (IN); Kamal AGRAWAL, Sohela (IN)

(21) Appl. No.: 19/067,626

(22) Filed: Feb. 28, 2025

(51) Int. Cl. G06T 1/20; G06Q 10/0639; G06T 1/60; G06T 17/00

(52) U.S. Cl. CPC G06T 1/20; G06Q 10/06393; G06T 1/60; G06T 17/00

(57) ABSTRACT

A processor-implemented method for boosting frequency for extended reality workloads includes receiving, by a boost management unit for a graphics processing unit (GPU), a GPU context of an extended reality (XR) application. The processor-implemented method also includes receiving an indication of a time warp workload, space warp workload, or a compositor workload. The boost management unit adapts a GPU frequency for processing the time warp workload, the space warp workload, or the compositor workload to a target frequency based on the indication of the time warp workload, the space warp workload, or the compositor workload.

### FIELD OF THE DISCLOSURE

The present disclosure relates generally to extended reality (XR) processing devices and more particularly to a smart asynchronous time warp (ATW) boost manager for XR.

### BACKGROUND

Extended reality (XR) is an umbrella term for any technology that alters reality by adding digital elements to the physical ore real world environment. XR includes augmented reality, mixed reality, and virtual reality, for instance. Augmented reality (AR) merges the real world with virtual objects to support realistic, intelligent, and personalized experiences. Conventional augmented reality applications provide a live view of a real-world environment whose elements may be augmented by computer-generated sensory input such as video, sound, graphics, or global positioning system (GPS) data. With such applications, a view of reality may be modified by a computing device, to enhance a user's perception of reality and provide more information about the user's environment. Virtual reality (VR) simulates physical presence in real or imagined worlds and enables the user to interact in that world.

Extended reality works by using visual data acquisition using a head-mounted display, smartglasses, or other visual data acquisition device. The visual data acquisition may be either accessed locally or shared and transferred over a network and to the human senses. By enabling real-time responses in a virtual stimulus these devices create customized experiences.

One problem experienced in XR is judder. Judder refers to a mixture of smearing and strobing in the display (e.g., head-mounted display (HMD) or smartglasses) that becomes apparent when the user rapidly moves the display (e.g., user turns head). The judder effect may significantly reduce the visual quality of the XR display and may cause the user to experience a form of motion sickness (also referred to as “simulator sickness”).

### SUMMARY

Various aspects of the present disclosure are directed to an apparatus. The apparatus has at least one memory and one or more processors coupled to the at least one memory. The processor(s) is configured to receive, by a boost management unit for a graphics processing unit (GPU), a GPU context of an extended reality (XR) application. The processor(s) is also configured to receive an indication of a time warp workload, space warp workload, or a compositor workload. The processor(s) is also configured to adapt, by the boost management unit, a GPU frequency for processing the time warp workload, the space warp workload, or the compositor workload to a target frequency based on the indication of the time warp workload, the space warp workload, or the compositor workload.

In some aspects of the present disclosure, a processor-implemented method includes receiving, by a boost management unit for a graphics processing unit (GPU), a GPU context of an extended reality (XR) application. The processor-implemented method also includes receiving an indication of a time warp workload, space warp workload, or a compositor workload. The processor-implemented method further includes adapting, by the boost management unit, a GPU frequency for processing the time warp workload, the space warp workload, or the compositor workload to a target frequency based on the indication of the time warp workload, the space warp workload, or the compositor workload.

Various aspects of the present disclosure are directed to an apparatus. The apparatus includes means for receiving, by a boost management unit for a graphics processing unit (GPU), a GPU context of an extended reality (XR) application. The apparatus also includes means for receiving an indication of a time warp workload, space warp workload, or a compositor workload. The apparatus further includes means for adapting, by the boost management unit, a GPU frequency for processing the time warp workload, the space warp workload, or the compositor workload to a target frequency based on the indication of the time warp workload, the space warp workload, or the compositor workload.

This has outlined, rather broadly, the features and technical advantages of the present disclosure in order that the detailed description that follows may be better understood. Additional features and advantages of the present disclosure will be described below. It should be appreciated by those skilled in the art that the present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF DRAWINGS

The details of one or more examples of the disclosure are set forth in the accompanying drawings and the description below. Other features, objects, and advantages of the disclosure will be apparent from the description and drawings, and from the claims.

FIG. 1 illustrates an example implementation of a system-on-a-chip (SoC).

FIG. 2 is a block diagram that illustrates an example content generation and coding system to implement extended reality (XR) applications, in accordance with various aspects of the present disclosure.

FIG. 3 is a block diagram illustrating XR subsystems such as augmented reality subsystems or virtual reality subsystems, according to various aspects of the present disclosure.

FIG. 4 is a diagram illustrating locations of components in a wearable device with an eyeglasses form factor, in accordance with various aspects of the present disclosure.

FIG. 5 is a block diagram illustrating an exemplary software architecture that may modularize extended reality (XR) functions, in accordance with various aspects of the present disclosure.

FIG. 6A is a block diagram illustrating example architecture for smart asynchronous time warp (ATW) boosting, in accordance with various aspects of the present disclosure.

FIG. 6B is a block diagram illustrating an example architecture for processing application tasks using graphics processing unit (GPU) hardware, in accordance with various aspects of the present disclosure.

FIG. 7 is a diagram illustrating an example process for dynamic frequency boosting for ATW workloads, in accordance with various aspects of the present disclosure.

FIG. 8 is a flow diagram illustrating a method of dynamic frequency adjustment for ATW workloads, according to various aspects of the present disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings one skilled in the art should appreciate that the scope of this disclosure is intended to cover any aspect of the systems, apparatuses, computer program products, and methods disclosed, whether implemented independently of, or combined with, other aspects of the disclosure. For example, an apparatus may be implemented or a method may be practiced using any number of the aspects set forth. In addition, the scope of the disclosure is intended to cover such an apparatus or method which is practiced using other structure, functionality, or structure and functionality in addition to or other than the various aspects of the disclosure set forth. Any aspect disclosed may be embodied by one or more elements of a claim.

Although various aspects are described, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, system-on-a-chips (SoCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described, one or more techniques may refer to an application (e.g., software) being configured to perform one or more functions. In such examples, the application may be stored on a memory (e.g., on-chip memory of a processor, system memory, or any other memory). Hardware described, such as a processor may be configured to execute the application. For example, the application may be described as including code that, when executed by the hardware, causes the hardware to perform one or more techniques described. As an example, the hardware may access the code from a memory and executed the code accessed from the memory to perform one or more techniques described. In some examples, components are identified in this disclosure. In such examples, the components may be hardware, software, or a combination thereof. The components may be separate components or sub-components of a single component.

Accordingly, in one or more examples described, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In general, this disclosure describes techniques for integrating subsystems or modules that are located on physically separated printed circuit boards (PCBs). For example, extended reality (XR) devices (e.g., augmented reality or virtual reality (AR/VR) devices) may have modules located physically distant from one another. However, the present disclosure is equally applicable to any type of system with modules or PCBs spaced apart but electrically connected (e.g., with a flex cable, a flex PCB, a coaxial cable, a rigid PCB, etc.) In some aspects, the solutions integrate at least one slave subsystem with a master subsystem by implementing all control and status monitor functions between the subsystems. For example, certain bi-directional functions may be implemented between master and slave subsystems, such as power on triggers, reset triggers, shutdown triggers, fault propagation, and fail-safe reset triggers.

As used, the term “coder” may generically refer to an encoder and/or decoder. For example, reference to a “content coder” may include reference to a content encoder and/or a content decoder. Similarly, as used, the term “coding” may generically refer to encoding and/or decoding. As used, the terms “encode” and “compress” may be used interchangeably. Similarly, the terms “decode” and “decompress” may be used interchangeably.

As used, instances of the term “content” may refer to the term “video,” “graphical content,” “image,” and vice versa. This is true regardless of whether the terms are being used as an adjective, noun, or other part of speech. For example, reference to a “content coder” may include reference to a “video coder,” “graphical content coder,” or “image coder,” and reference to a “video coder,” “graphical content coder,” or “image coder” may include reference to a “content coder.” As another example, reference to a processing unit providing content to a content coder may include reference to the processing unit providing graphical content to a video encoder. In some examples, the term “graphical content” may refer to a content produced by one or more processes of a graphics processing pipeline. In some examples, the term “graphical content” may refer to a content produced by a processing unit configured to perform graphics processing. In some examples, the term “graphical content” may refer to a content produced by a graphics processing unit.

Instances of the term “content” may refer to graphical content or display content. In some examples, the term “graphical content” may refer to a content generated by a processing unit configured to perform graphics processing. For example, the term “graphical content” may refer to content generated by one or more processes of a graphics processing pipeline. In some examples, the term “graphical content” may refer to content generated by a graphics processing unit. In some examples, as used herein, the term “display content” may refer to content generated by a processing unit configured to perform displaying processing. In some examples, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling (e.g., upscaling or downscaling) on a frame. In some examples, a frame may refer to a layer. In other examples, a frame may refer to two or more layers that have already been blended together to form the frame (e.g., the frame includes two or more layers, and the frame that includes two or more layers may subsequently be blended)

As referenced, a first component (e.g., a processing unit) may provide content, such as graphical content, to a second component (e.g., a content coder). In some examples, the first component may provide content to the second component by storing the content in a memory accessible to the second component. In such examples, the second component may be configured to read the content stored in the memory by the first component. In other examples, the first component may provide content to the second component without any intermediary components (e.g., without memory or another component). In such examples, the first component may be described as providing content directly to the second component. For example, the first component may output the content to the second component, and the second component may be configured to store the content received from the first component in a memory, such as a buffer.

For a mobile device, such as a mobile telephone, a single printed circuit board (PCB) may support multiple components including a CPU, GPU, DSP, etc. For an XR device, the components may be located on different PCBs due to the form factor of the XR device. For example, the XR device may be in the form of eyeglasses. In an example implementation, a main SoC (also referred to as a main processor) and a main power management integrated circuit (PMIC) may reside on a first PCB in one of the arms of the eyeglasses. A camera and sensor co-processor and associated PMIC may reside on a second PCB near the bridge of the eyeglasses. A connectivity processor and associated PMIC may reside on a third PCB on the other arm of the eyeglasses.

Asynchronous time warp (ATW) is a technique for addressing the problem of judder in extended radio devices. Judder refers to a mixture of smearing and strobing in the head-mounted display (HMD), smart glasses or other XR display that becomes apparent when the user moves the HMD quickly (e.g., user turns their head). ATW generates intermediate frames when the XR application (e.g., video game) is unable to maintain the perceived smoothness of motion when the application frame rate drops below a target refresh rate (e.g., 90 Hertz (Hz)).

Time warping (also referred to as reprojection) is a technique in which the HMD driver takes one or more previously rendered frames and uses motion information from a current frame to warp (e.g., extrapolate or reproject) the previous frame into a prediction of a normally rendered frame prior to sending the frame to the display. The asynchronous term in ATW indicates that the time warping process is continuously performed in parallel with rendering. That is, the ATW may operate independently of the render engine (e.g., graphics processing unit (GPU)). In doing so, ATW may allow the warped frames to be displayed within the delay of the unwarped frame.

In XR, enhancing the performance of asynchronous time warp (ATW) workloads is important for providing a seamless and immersive user experience ensuring certain key performance indicator (KPI) metrics are in an acceptable range. ATW contexts running on the GPU are highly time-sensitive and demand minimal latency to ensure timely completion.

Conventional ATW approaches may employ dynamic clock and voltage scaling (DCVS) such as GPU DCVS. In the conventional ATW approaches, a kernel driver (e.g., a kernel graphics support layer (KGSL)) reads performance counters periodically, and decides whether to increase or decrease the GPU frequency using the DCVS process. However, the conventional ATW approaches include overhead extending from a user mode driver (UMD), which takes an application programming interface (API) request and provides the request to the kernel mode driver (KMD), the flow including the KMD to CPU-scheduling to sampling to a graphics management unit (GMU), before ultimately adjusting the clock frequency. As such, the conventional ATW approaches may fail to meet the high GPU frequency demands during ATW workloads due to their longer sampling times and continuous submissions every few milliseconds (ms).

Accordingly, aspects of the present disclosure are directed to a smart workload boost manager for XR. The smart workload boost manager may dynamically adjust during runtime, the GPU frequency of ATW workloads to a target frequency. In some aspects, the smart workload boost manager may be implemented in logic of a graphics management unit (GMU).

Because the workloads of ATW may be constant, the target frequency for the GPU (or cache, double data rate memory (DDR), etc.) may be pre-determined. As such, the smart workload boost manager may boost GPU frequency and DDR bus frequency directly, without waiting for any DCVS/CPU scheduling overhead, which may reduce latency in processing the ATW workload. In some aspects, the boost management device may also be applied to other workloads including (but not limited to) time warp workloads, space warp workload, and compositor workloads, for instance.

Space warp refers to generating extrapolated frames form previous frames other than those related to head movement. A compositor performs operations between an application submitting a frame and draws the frame of an XR display. The compositor may distort frames and may add compositor layers to render a texture for an application.

Furthermore, in some aspects, the smart workload boost manager may also adapt a cache policy change, a memory access priority, as well as underlying system resources for hardware and software priority changes. For instance, the smart workload boost manager may initiate changes including (but not limited to) disabling clean eviction policy overhead, allocating a larger cache size, adapting the priority of access over other intellectual property (IP) processor clients, increase priority of software and/or hardware threads (e.g., changed to RT priority) to enable faster access of underlying resources.

Particular aspects of the subject matter described in this disclosure can be implemented to realize one or more of the following potential advantages. In some examples, the described techniques, (e.g., adapting, by the boost management unit, a GPU frequency for processing the time warp workload, the space warp workload, or the compositor workload to a target frequency based on the indication of the time warp workload, the space warp workload, or the compositor workload) may reduce warp latency and increase power efficiency in XR devices (e.g., smartglasses or HMD).

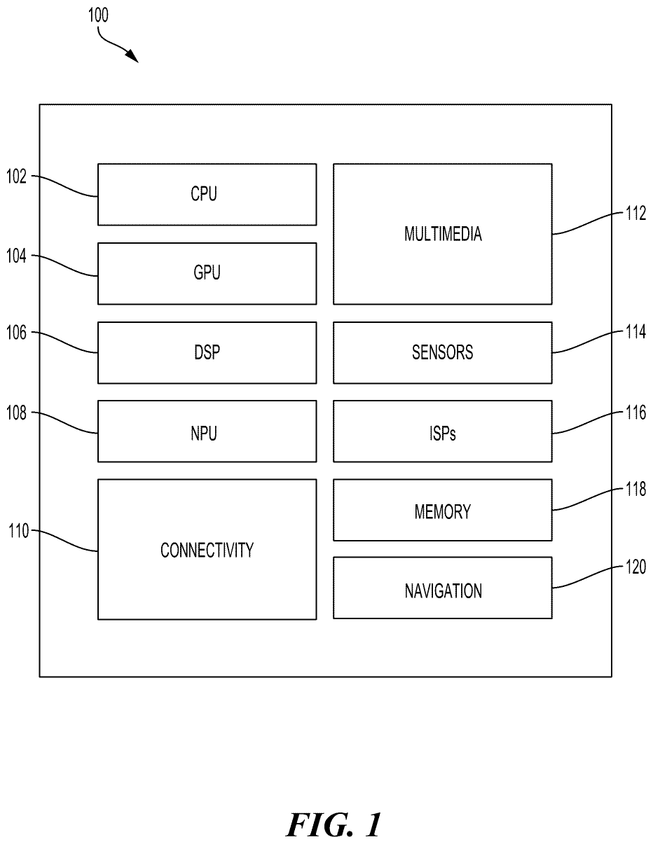

FIG. 1 illustrates an example implementation of a system-on-a-chip (SoC) 100 on a single printed circuit board (PCB). The host SoC 100 includes processing blocks tailored to specific functions, such as a connectivity block 110. The connectivity block 110 may include fifth generation (5G) new radio (NR) connectivity, fourth generation long term evolution (4G LTE) connectivity, Wi-Fi connectivity, USB connectivity, Bluetooth® connectivity, Secure Digital (SD) connectivity, and the like.

In this configuration, the SoC 100 includes various processing units that support multi-threaded operation. For the configuration shown in FIG. 1, the SoC 100 includes a multi-core central processing unit (CPU) 102, a graphics processor unit (GPU) 104, a digital signal processor (DSP) 106, and a neural processor unit (NPU) 108. The SoC 100 may also include a sensor processor 114, image signal processors (ISPs) 116, a navigation module 120, which may include a global positioning system, and a memory 118. The multi-core CPU 102, the GPU 104, the DSP 106, the NPU 108, and the multi-media engine 112 support various functions such as video, audio, graphics, extended reality (XR) gaming, artificial networks, and the like. Each processor core of the multi-core CPU 102 may be a reduced instruction set computing (RISC) machine, an advanced RISC machine (ARM), a microprocessor, or some other type of processor. The NPU 108 may be based on an ARM instruction set.

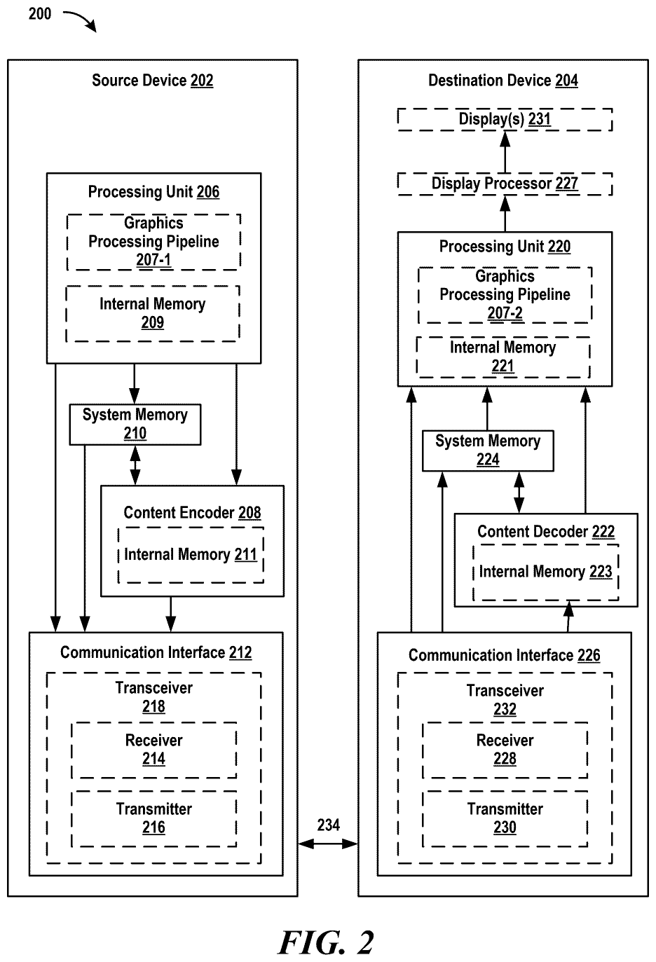

FIG. 2 is a block diagram that illustrates an example extended reality (XR) system 200 configured to implement XR applications, according to aspects of the present disclosure. The system 200 includes a source device 202 and a destination device 204. In accordance with the techniques described, the source device 202 may be configured to encode, using the content encoder 208, graphical content generated by the processing unit 206 prior to transmission to the destination device 204. The content encoder 208 may be configured to output a bitstream having a bit rate. The processing unit 206 may be configured to control and/or influence the bit rate of the content encoder 208 based on how the processing unit 206 generates graphical content.

The source device 202 may include one or more components (or circuits) for performing various functions described herein. The destination device 204 may include one or more components (or circuits) for performing various functions described. In some examples, one or more components of the source device 202 may be components of a system-on-a-chip (SoC). Similarly, in some examples, one or more components of the destination device 204 may be components of an SoC.

The source device 202 may include one or more components configured to perform one or more techniques of this disclosure. In the example shown, the source device 202 may include a processing unit 206, a content encoder 208, a system memory 210, and a communication interface 212. The processing unit 206 may include an internal memory 209. The processing unit 206 may be configured to perform graphics processing, such as in a graphics processing pipeline 207-1. The content encoder 208 may include an internal memory 211.

Memory external to the processing unit 206 and the content encoder 208, such as system memory 210, may be accessible to the processing unit 206 and the content encoder 208. For example, the processing unit 206 and the content encoder 208 may be configured to read from and/or write to external memory, such as the system memory 210. The processing unit 206 and the content encoder 208 may be communicatively coupled to the system memory 210 over a bus. In some examples, the processing unit 206 and the content encoder 208 may be communicatively coupled to each other over the bus or a different connection.

The content encoder 208 may be configured to receive graphical content from any source, such as the system memory 210 and/or the processing unit 206. The system memory 210 may be configured to store graphical content generated by the processing unit 206. For example, the processing unit 206 may be configured to store graphical content in the system memory 210. The content encoder 208 may be configured to receive graphical content (e.g., from the system memory 210 and/or the processing unit 206) in the form of pixel data. Otherwise described, the content encoder 208 may be configured to receive pixel data of graphical content produced by the processing unit 206. For example, the content encoder 208 may be configured to receive a value for each component (e.g., each color component) of one or more pixels of graphical content. As an example, a pixel in the red, green, blue (RGB) color space may include a first value for the red component, a second value for the green component, and a third value for the blue component.

The internal memory 209, the system memory 210, and/or the internal memory 211 may include one or more volatile or non-volatile memories or storage devices. In some examples, internal memory 209, the system memory 210, and/or the internal memory 211 may include random access memory (RAM), static RAM (SRAM), dynamic RAM (DRAM), erasable programmable ROM (EPROM), electrically erasable programmable ROM (EEPROM), Flash memory, a magnetic data media or an optical storage media, or any other type of memory.

The internal memory 209, the system memory 210, and/or the internal memory 211 may be a non-transitory storage medium according to some examples. The term “non-transitory” may indicate that the storage medium is not embodied in a carrier wave or a propagated signal. However, the term “non-transitory” should not be interpreted to mean that internal memory 209, the system memory 210, and/or the internal memory 211 is non-movable or that its contents are static. As one example, the system memory 210 may be removed from the source device 202 and moved to another device. As another example, the system memory 210 may not be removable from the source device 202.

The processing unit 206 may be a central processing unit (CPU), a graphics processing unit (GPU), a general purpose GPU (GPGPU), or any other processing unit that may be configured to perform graphics processing. In some examples, the processing unit 206 may be integrated into a motherboard of the source device 202. In some examples, the processing unit 206 may be present on a graphics card that is installed in a port in a motherboard of the source device 202, or may be otherwise incorporated within a peripheral device configured to interoperate with the source device 202.

The processing unit 206 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 206 may store instructions for the software in a suitable, non-transitory computer-readable storage medium (e.g., internal memory 209), and may execute the instructions in hardware using one or more processors to perform the techniques of this disclosure. Any of the foregoing (including hardware, software, a combination of hardware and software, etc.) may be considered to be one or more processors.

The content encoder 208 may be any processing unit configured to perform content encoding. In some examples, the content encoder 208 may be integrated into a motherboard of the source device 202. The content encoder 208 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the content encoder 208 may store instructions for the software in a suitable, non-transitory computer-readable storage medium (e.g., internal memory 211), and may execute the instructions in hardware using one or more processors to perform the techniques of this disclosure. Any of the foregoing (including hardware, software, a combination of hardware and software, etc.) may be considered to be one or more processors.

The communication interface 212 may include a receiver 214 and a transmitter 216. The receiver 214 may be configured to perform any receiving function described with respect to the source device 202. For example, the receiver 214 may be configured to receive information from the destination device 204, which may include a request for content. In some examples, in response to receiving the request for content, the source device 202 may be configured to perform one or more techniques described, such as produce or otherwise generate graphical content for delivery to the destination device 204. The transmitter 216 may be configured to perform any transmitting function described herein with respect to the source device 202. For example, the transmitter 216 may be configured to transmit encoded content to the destination device 204, such as encoded graphical content produced by the processing unit 206 and the content encoder 208 (e.g., the graphical content is produced by the processing unit 206, which the content encoder 208 receives as input to produce or otherwise generate the encoded graphical content). The receiver 214 and the transmitter 216 may be combined into a transceiver 218. In such examples, the transceiver 218 may be configured to perform any receiving function and/or transmitting function described with respect to the source device 202.

The destination device 204 may include one or more components configured to perform one or more techniques of this disclosure. In the example shown, the destination device 204 may include a processing unit 220, a content decoder 222, a system memory 224, a communication interface 226, and one or more displays 231. Reference to the displays 231 may refer to the one or more displays 231. For example, the displays 231 may include a single display or multiple displays. The displays 231 may include a first display and a second display. The first display may be a left-eye display and the second display may be a right-eye display. In some examples, the first and second display may receive different frames for presentment thereon. In other examples, the first and second display may receive the same frames for presentment thereon.

The processing unit 220 may include an internal memory 221. The processing unit 220 may be configured to perform graphics processing, such as in a graphics processing pipeline 207-2. The content decoder 222 may include an internal memory 223. In some examples, the destination device 204 may include a display processor, such as the display processor 227, to perform one or more display processing techniques on one or more frames generated by the processing unit 220 before presentment by the one or more displays 231. The display processor 227 may be configured to perform display processing. For example, the display processor 227 may be configured to perform one or more display processing techniques on one or more frames generated by the processing unit 220. The one or more displays 231 may be configured to display content that was generated using decoded content. For example, the display processor 227 may be configured to process one or more frames generated by the processing unit 220, where the one or more frames are generated by the processing unit 220 by using decoded content that was derived from encoded content received from the source device 202. In turn the display processor 227 may be configured to perform display processing on the one or more frames generated by the processing unit 220. The one or more displays 231 may be configured to display or otherwise present frames processed by the display processor 227. In some examples, the one or more display devices may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 220 and the content decoder 222, such as system memory 224, may be accessible to the processing unit 220 and the content decoder 222. For example, the processing unit 220 and the content decoder 222 may be configured to read from and/or write to external memory, such as the system memory 224. The processing unit 220 and the content decoder 222 may be communicatively coupled to the system memory 224 over a bus. In some examples, the processing unit 220 and the content decoder 222 may be communicatively coupled to each other over the bus or a different connection.

The content decoder 222 may be configured to receive graphical content from any source, such as the system memory 224 and/or the communication interface 226. The system memory 224 may be configured to store received encoded graphical content, such as encoded graphical content received from the source device 202. The content decoder 222 may be configured to receive encoded graphical content (e.g., from the system memory 224 and/or the communication interface 226) in the form of encoded pixel data. The content decoder 222 may be configured to decode encoded graphical content.

The internal memory 221, the system memory 224, and/or the internal memory 223 may include one or more volatile or non-volatile memories or storage devices. In some examples, internal memory 221, the system memory 224, and/or the internal memory 223 may include random access memory (RAM), static RAM (SRAM), dynamic RAM (DRAM), erasable programmable ROM (EPROM), electrically erasable programmable ROM (EEPROM), Flash memory, a magnetic data media or an optical storage media, or any other type of memory.

The internal memory 221, the system memory 224, and/or the internal memory 223 may be a non-transitory storage medium according to some examples. The term “non-transitory” may indicate that the storage medium is not embodied in a carrier wave or a propagated signal. However, the term “non-transitory” should not be interpreted to mean that internal memory 221, the system memory 224, and/or the internal memory 223 is non-movable or that its contents are static. As one example, the system memory 224 may be removed from the destination device 204 and moved to another device. As another example, the system memory 224 may not be removable from the destination device 204.

The processing unit 220 may be a central processing unit (CPU), a graphics processing unit (GPU), a general purpose GPU (GPGPU), or any other processing unit that may be configured to perform graphics processing. In some examples, the processing unit 220 may be integrated into a motherboard of the destination device 204. In some examples, the processing unit 220 may be present on a graphics card that is installed in a port in a motherboard of the destination device 204, or may be otherwise incorporated within a peripheral device configured to interoperate with the destination device 204.

The processing unit 220 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 220 may store instructions for the software in a suitable, non-transitory computer-readable storage medium (e.g., internal memory 221), and may execute the instructions in hardware using one or more processors to perform the techniques of this disclosure. Any of the foregoing (including hardware, software, a combination of hardware and software, etc.) may be considered to be one or more processors.

The content decoder 222 may be any processing unit configured to perform content decoding. In some examples, the content decoder 222 may be integrated into a motherboard of the destination device 204. The content decoder 222 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the content decoder 222 may store instructions for the software in a suitable, non-transitory computer-readable storage medium (e.g., internal memory 223), and may execute the instructions in hardware using one or more processors to perform the techniques of this disclosure. Any of the foregoing (including hardware, software, a combination of hardware and software, etc.) may be considered to be one or more processors.

The communication interface 226 may include a receiver 228 and a transmitter 230. The receiver 228 may be configured to perform any receiving function described herein with respect to the destination device 204. For example, the receiver 228 may be configured to receive information from the source device 202, which may include encoded content, such as encoded graphical content produced or otherwise generated by the processing unit 206 and the content encoder 208 of the source device 202 (e.g., the graphical content is produced by the processing unit 206, which the content encoder 208 receives as input to produce or otherwise generate the encoded graphical content). As another example, the receiver 228 may be configured to receive position information from the source device 202, which may be encoded or unencoded (e.g., not encoded). In some examples, the destination device 204 may be configured to decode encoded graphical content received from the source device 202 in accordance with the techniques described herein. For example, the content decoder 222 may be configured to decode encoded graphical content to produce or otherwise generate decoded graphical content. The processing unit 220 may be configured to use the decoded graphical content to produce or otherwise generate one or more frames for presentment on the one or more displays 231. The transmitter 230 may be configured to perform any transmitting function described herein with respect to the destination device 204. For example, the transmitter 230 may be configured to transmit information to the source device 202, which may include a request for content. The receiver 228 and the transmitter 230 may be combined into a transceiver 232. In such examples, the transceiver 232 may be configured to perform any receiving function and/or transmitting function described herein with respect to the destination device 204.

The content encoder 208 and the content decoder 222 of XR gaming system 200 represent examples of computing components (e.g., processing units) that may be configured to perform one or more techniques for encoding content and decoding content in accordance with various examples described in this disclosure, respectively. In some examples, the content encoder 208 and the content decoder 222 may be configured to operate in accordance with a content coding standard, such as a video coding standard, a display stream compression standard, or an image compression standard.

As shown in FIG. 2, the source device 202 may be configured to generate encoded content. Accordingly, the source device 202 may be referred to as a content encoding device or a content encoding apparatus. The destination device 204 may be configured to decode the encoded content generated by source device 202. Accordingly, the destination device 204 may be referred to as a content decoding device or a content decoding apparatus. In some examples, the source device 202 and the destination device 204 may be separate devices, as shown. In other examples, source device 202 and destination device 204 may be on or part of the same computing device. In either example, a graphics processing pipeline may be distributed between the two devices. For example, a single graphics processing pipeline may include a plurality of graphics processes. The graphics processing pipeline 207-1 may include one or more graphics processes of the plurality of graphics processes. Similarly, graphics processing pipeline 207-2 may include one or more processes graphics processes of the plurality of graphics processes. In this regard, the graphics processing pipeline 207-1 concatenated or otherwise followed by the graphics processing pipeline 207-2 may result in a full graphics processing pipeline. Otherwise described, the graphics processing pipeline 207-1 may be a partial graphics processing pipeline and the graphics processing pipeline 207-2 may be a partial graphics processing pipeline that, when combined, result in a distributed graphics processing pipeline.

In some examples, a graphics process performed in the graphics processing pipeline 207-1 may not be performed or otherwise repeated in the graphics processing pipeline 207-2. For example, the graphics processing pipeline 207-1 may include receiving first position information corresponding to a first orientation of a device. The graphics processing pipeline 207-1 may also include generating first graphical content based on the first position information. Additionally, the graphics processing pipeline 207-1 may include generating motion information for warping the first graphical content. The graphics processing pipeline 207-1 may further include encoding the first graphical content. Also, the graphics processing pipeline 207-1 may include providing the motion information and the encoded first graphical content. The graphics processing pipeline 207-2 may include providing first position information corresponding to a first orientation of a device. The graphics processing pipeline 207-2 may also include receiving encoded first graphical content generated based on the first position information. Further, the graphics processing pipeline 207-2 may include receiving motion information. The graphics processing pipeline 207-2 may also include decoding the encoded first graphical content to generate decoded first graphical content. Also, the graphics processing pipeline 207-2 may include warping the decoded first graphical content based on the motion information. By distributing the graphics processing pipeline between the source device 202 and the destination device 204, the destination device may be able to, in some examples, present graphical content that it otherwise would not be able to render; and, therefore, could not present. Other example benefits are described throughout this disclosure.

As described, a device, such as the source device 202 and/or the destination device 204, may refer to any device, apparatus, or system configured to perform one or more techniques described. For example, a device may be a server, a base station, user equipment, a client device, a station, an access point, a computer (e.g., a personal computer, a desktop computer, a laptop computer, a tablet computer, a computer workstation, or a mainframe computer), an end product, an apparatus, a phone, a smart phone, a server, a video game platform or console, a handheld device (e.g., a portable video game device or a personal digital assistant (PDA)), a wearable computing device (e.g., a smart watch, an augmented reality device, or a virtual reality device), a non-wearable device, an augmented reality device, a virtual reality device, a display (e.g., display device), a television, a television set-top box, an intermediate network device, a digital media player, a video streaming device, a content streaming device, an in-car computer, any mobile device, any device configured to generate graphical content, or any device configured to perform one or more techniques described herein.

Source device 202 may be configured to communicate with the destination device 204. For example, destination device 204 may be configured to receive encoded content from the source device 202. In some example, the communication coupling between the source device 202 and the destination device 204 is shown as link 234. Link 234 may comprise any type of medium or device capable of moving the encoded content from source device 202 to the destination device 204.

In the example of FIG. 2, link 234 may comprise a communication medium to enable the source device 202 to transmit encoded content to destination device 204 in real-time. The encoded content may be modulated according to a communication standard, such as a wireless communication protocol, and transmitted to destination device 204. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 202 to the destination device 204. In other examples, link 234 may be a point-to-point connection between source device 202 and destination device 204, such as a wired or wireless display link connection (e.g., a high-definition multimedia interface (HDMI) link, a DisplayPort link, mobile industry processor interface (MIPI) display serial interface (DSI) link, or another link over which encoded content may traverse from the source device 202 to the destination device 204.

In another example, the link 234 may include a storage medium configured to store encoded content generated by the source device 202. In this example, the destination device 204 may be configured to access the storage medium. The storage medium may include a variety of locally-accessed data storage media such as Blu-ray discs, DVDs, CD-ROMs, flash memory, or other suitable digital storage media for storing encoded content.

In another example, the link 234 may include a server or another intermediate storage device configured to store encoded content generated by the source device 202. In this example, the destination device 204 may be configured to access encoded content stored at the server or other intermediate storage device. The server may be a type of server capable of storing encoded content and transmitting the encoded content to the destination device 204.

Devices described may be configured to communicate with each other, such as the source device 202 and the destination device 204. Communication may include the transmission and/or reception of information. The information may be carried in one or more messages. As an example, a first device in communication with a second device may be described as being communicatively coupled to or otherwise with the second device. For example, a client device and a server may be communicatively coupled. As another example, a server may be communicatively coupled to multiple client devices. As another example, any device described configured to perform one or more techniques of this disclosure may be communicatively coupled to one or more other devices configured to perform one or more techniques of this disclosure. In some examples, when communicatively coupled, two devices may be actively transmitting or receiving information, or may be configured to transmit or receive information. If not communicatively coupled, any two devices may be configured to communicatively couple with each other, such as in accordance with one or more communication protocols compliant with one or more communication standards. Reference to “any two devices” does not mean that only two devices may be configured to communicatively couple with each other; rather, any two devices are inclusive of more than two devices. For example, a first device may communicatively couple with a second device and the first device may communicatively couple with a third device. In such an example, the first device may be a server.

With reference to FIG. 2, the source device 202 may be described as being communicatively coupled to the destination device 204. In some examples, the term “communicatively coupled” may refer to a communication connection, which may be direct or indirect. The link 234 may, in some examples, represent a communication coupling between the source device 202 and the destination device 204. A communication connection may be wired and/or wireless. A wired connection may refer to a conductive path, a trace, or a physical medium (excluding wireless physical mediums) over which information may travel. A conductive path may refer to any conductor of any length, such as a conductive pad, a conductive via, a conductive plane, a conductive trace, or any conductive medium. A direct communication connection may refer to a connection in which no intermediary component resides between the two communicatively coupled components. An indirect communication connection may refer to a connection in which at least one intermediary component resides between the two communicatively coupled components. Two devices that are communicatively coupled may communicate with each other over one or more different types of networks (e.g., a wireless network and/or a wired network) in accordance with one or more communication protocols. In some examples, two devices that are communicatively coupled may associate with one another through an association process. In other examples, two devices that are communicatively coupled may communicate with each other without engaging in an association process. For example, a device, such as the source device 202, may be configured to unicast, broadcast, multicast, or otherwise transmit information (e.g., encoded content) to one or more other devices (e.g., one or more destination devices, which includes the destination device 204). The destination device 204 in this example may be described as being communicatively coupled with each of the one or more other devices. In some examples, a communication connection may enable the transmission and/or receipt of information. For example, a first device communicatively coupled to a second device may be configured to transmit information to the second device and/or receive information from the second device in accordance with the techniques of this disclosure. Similarly, the second device in this example may be configured to transmit information to the first device and/or receive information from the first device in accordance with the techniques of this disclosure. In some examples, the term “communicatively coupled” may refer to a temporary, intermittent, or permanent communication connection.

Any device described, such as the source device 202 and the destination device 204, may be configured to operate in accordance with one or more communication protocols. For example, the source device 202 may be configured to communicate with (e.g., receive information from and/or transmit information to) the destination device 204 using one or more communication protocols. In such an example, the source device 202 may be described as communicating with the destination device 204 over a connection. The connection may be compliant or otherwise be in accordance with a communication protocol. Similarly, the destination device 204 may be configured to communicate with (e.g., receive information from and/or transmit information to) the source device 202 using one or more communication protocols. In such an example, the destination device 204 may be described as communicating with the source device 202 over a connection. The connection may be compliant or otherwise be in accordance with a communication protocol.

The term “communication protocol” may refer to any communication protocol, such as a communication protocol compliant with a communication standard or the like. As used herein, the term “communication standard” may include any communication standard, such as a wireless communication standard and/or a wired communication standard. A wireless communication standard may correspond to a wireless network. As an example, a communication standard may include any wireless communication standard corresponding to a wireless personal area network (WPAN) standard, such as Bluetooth (e.g., IEEE 802.15), Bluetooth low energy (BLE) (e.g., IEEE 802.15.4). As another example, a communication standard may include any wireless communication standard corresponding to a wireless local area network (WLAN) standard, such as WI-FI (e.g., any 802.11 standard, such as 802.11a, 802.11b, 802.11c, 802.11n, or 802.11ax). As another example, a communication standard may include any wireless communication standard corresponding to a wireless wide area network (WWAN) standard, such as 3G, 4G, 4G LTE, 5G, or 6G.

With reference to FIG. 2, the content encoder 208 may be configured to encode graphical content. In some examples, the content encoder 208 may be configured to encode graphical content as one or more video frames of XR content. When the content encoder 208 encodes content, the content encoder 208 may generate a bitstream. The bitstream may have a bit rate, such as bits/time unit, where time unit is any time unit, such as second or minute. The bitstream may include a sequence of bits that form a coded representation of the graphical content and associated data. To generate the bitstream, the content encoder 208 may be configured to perform encoding operations on pixel data, such as pixel data corresponding to a shaded texture atlas. For example, when the content encoder 208 performs encoding operations on image data (e.g., one or more blocks of a shaded texture atlas) provided as input to the content encoder 208, the content encoder 208 may generate a series of coded images and associated data. The associated data may include a set of coding parameters such as a quantization parameter (QP).

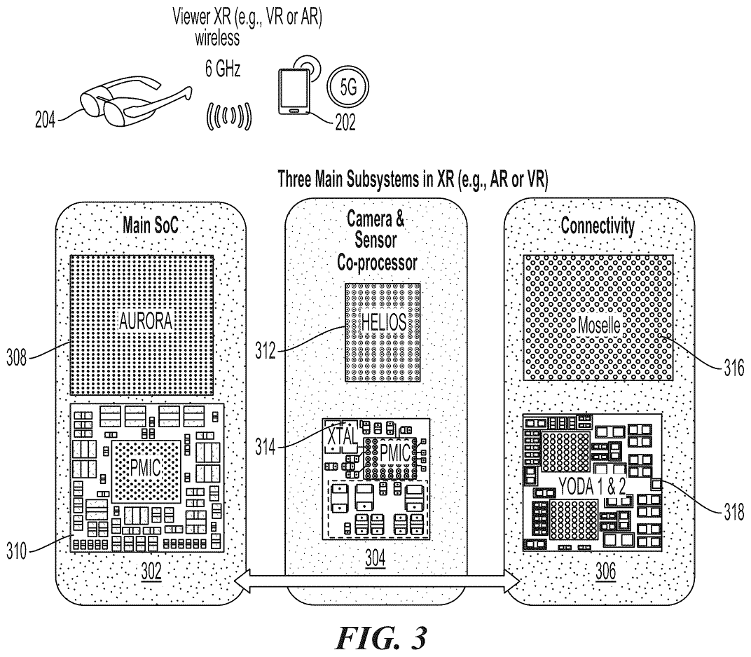

As shown in FIG. 1, a single printed circuit board (PCB) may support multiple components of the SoC 100, including the CPU 102, GPU 104, DSP 106, etc. For an XR device, the components may be located on different PCBs. FIG. 3 is a block diagram illustrating XR subsystems such as augmented reality subsystems or virtual reality subsystems, according to aspects of the present disclosure. As seen in the example of FIG. 3, the destination device 204 may be in the form of eyeglasses and the source device 202 may be in the form of a mobile device. In some aspects, the destination device 204 may be in the form of a headset (e.g., HMD), for example. If the destination device 204 has an eyeglasses form factor, the various components may be distributed across multiple PCBs 302, 304, 306 in a multi-PCB architecture. For example, a master or main SoC 308 and a master power management integrated circuit (PMIC) 310 may reside on a first PCB 302, a camera and sensor co-processor 312 and associated PMIC 314 may reside on a second PCB 304, and a connectivity processor 316 and associated PMIC 318 may reside on a third PCB 306. Due to the separate locations of the PCBs 302, 304, 306, the length of connectors between the PCBs 302, 304, 306 may exceed design specifications. Moreover, the connectors may be arranged in a multi-drop configuration, which also impedes performance due to stubs and reflections. Flexible PCBs may also be used between PCBs 302, 304, 306, which may further impact signal integrity.

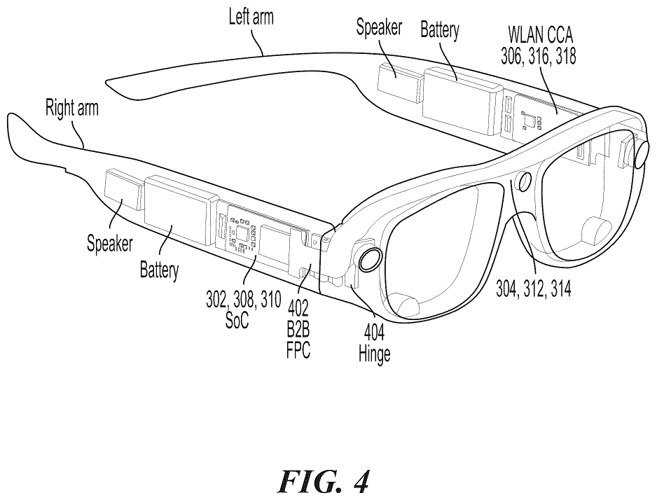

FIG. 4 is a diagram illustrating placement of components in a XR device with an eyeglasses form factor, in accordance with aspects of the present disclosure. The XR device may, for instance, comprise (but is not limited to) AR glasses, VR glasses or an AR/VR headset. As seen in the example of FIG. 4, the master SoC 308 and master power management IC (PMIC) 310 may reside on the first PCB 302 (also referred to as CCA-circuit card assembly) in one arm of the glasses, the camera and sensor co-processor 312 and associated PMIC 314 may reside on the second PCB 304 on the bridge of the eyeglasses, and the connectivity processor 316 and associated PMIC 318 may reside on the third PCB 306 on another arm of the glasses. Location of batteries and speakers are also shown in FIG. 4. A board-to-board (B2B) flexible printed circuit (FPC) connector 402 couples the first PCB 302, the second PCB 304, and the third PCB 306 across hinges 404 (only one labelled) of the eyeglasses.

Due to the small form factor of the device, small PCBs are provided, and thus there is small PCB area availability. Due to signals traveling across hinges, signal integrity may be affected. Moreover, the lengthy channels (e.g., up to 20 cm-25 cm from one arm to another arm of the eyeglasses) and channels on flex cables with high insertion loss may cause signal integrity issues for high-speed signals, such as system power management interface (SPMI) protocol signals. The small form factor of the eyeglasses specifies small board-to-board connectors. The small size places severe constraints on wires crossing hinges. For example, the number of signals able to be sent across hinges may be limited. Furthermore, the small volume of the eyeglasses frame constrains the trace thickness, limiting sharing of power rails across subsystems.

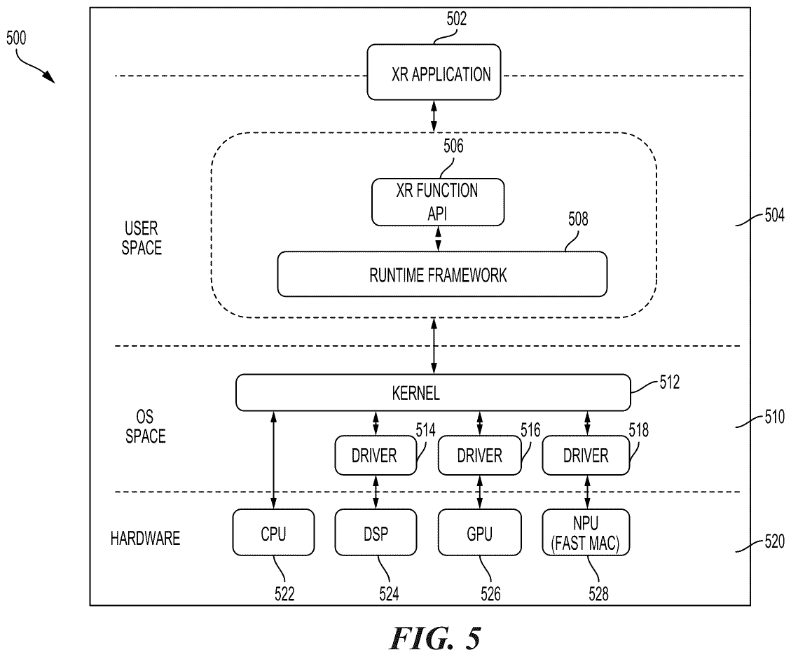

FIG. 5 is a block diagram illustrating an exemplary software architecture 500 that may modularize XR application functions. Using the architecture 500, XR applications may be designed that may cause various processing blocks of an SoC 520 (for example, a CPU 522, a DSP 524, a GPU 526 and/or an NPU 528) to support dynamic graphics clock boosting for ATW workloads of an XR application 502, according to aspects of the present disclosure. The architecture 500 may, for example, be included in a computational device, such as a smartphone, an HMD, smartglasses or other XR devices.

The XR application 502 may be configured to call functions defined in a user space 504 that may, for example, provide for the detection of rapid motion of the computational device including the architecture 500. The XR application 502 may, for example, determine whether to perform ATW based for example on a comparison of the refresh rate of a display for the computational device and the clock frequency of the GPU 526. The XR application 502 may make a request to compiled program code associated with a library defined in a XR function application programming interface (API) 506.

The run-time engine 508, which may be compiled code of a runtime framework, may be further accessible to the XR application 502. The CPU 522 may be accessed directly by the operating system, and other processing blocks may be accessed through a driver, such as a driver 514, 516, or 518 for, respectively, the DSP 524, the GPU 526, or the NPU 528.

As described, aspects of the present disclosure are directed to an asynchronous time warp (ATW) boost manager.

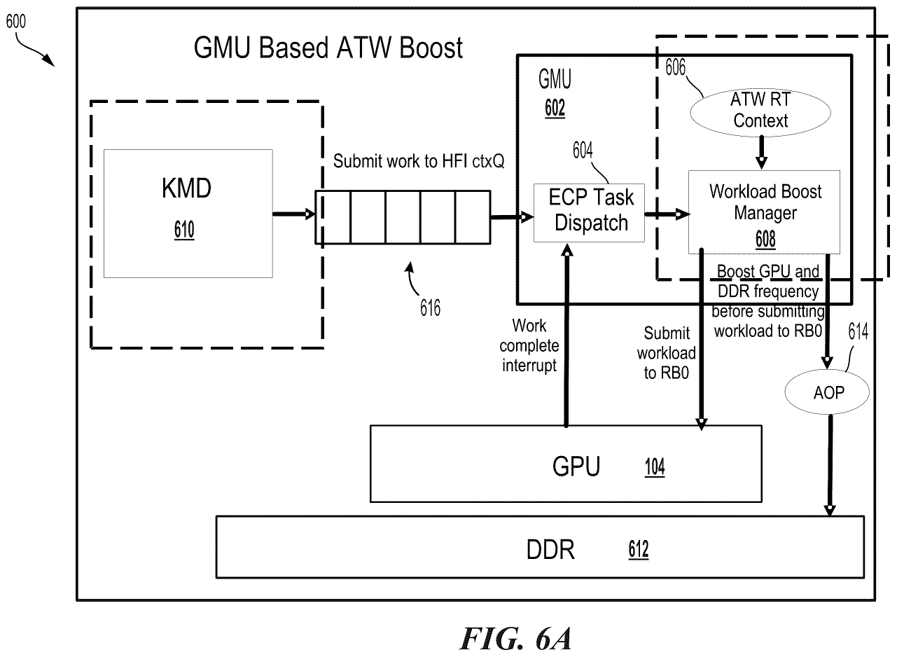

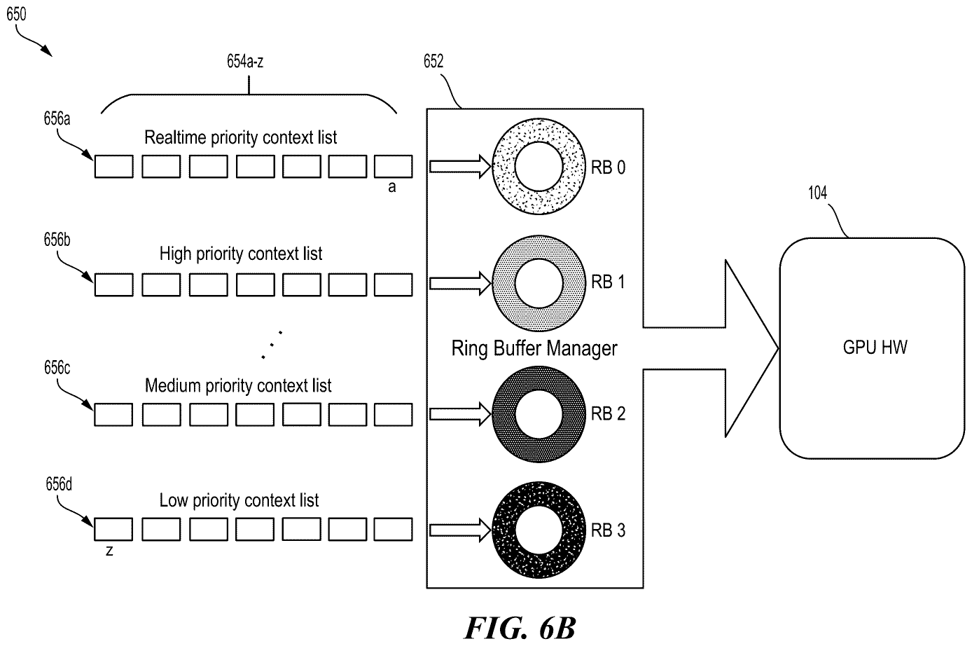

FIG. 6A is a block diagram illustrating an example architecture 600 for smart ATW boosting, in accordance with various aspects of the present disclosure. Referring to FIG. 6A, the example architecture 600 includes a graphics management unit (GMU) 602, the GPU 104, and a double data rate memory (DDR) bus 612. The GMU 602 may provide a programmable power controller for the GPU 104. The GMU 602 may include a workload boost manager 608 that may adapt the GPU frequency before submitting the workload to the GPU 104. The workload boost manager 608 may be implemented in firmware of the GMU 602.

The workload boost manager 608 may submit the ATW workload as a high priority context at a ring buffer RB0. A ring buffer may be considered a data structure that uses a single fixed length array arranged as if connected end-to-end with two pointers, one pointer representing the head of a queue and the other pointer representing the tail of the queue. The ring buffer may be considered a queue for the GPU 104. The GPU 104 may have multiple levels of ring buffers arranged according to priority. RB0 may represent the highest priority such that GPU contexts in the RB0 priority level may be processed before GPU contexts in other priority levels. ATW may be statically configured in an operating system (OS) through the KMD context create API as a real time (RT) priority (e.g., using VULKAN or OPENGL). In some aspects, the workload boost manager 608 may also modify an ATW context identifier (ID) from high priority to real time (RT) priority. In various aspects, the workload boost manager 608 may boost processing frequency of the ATW workload according to a sliding window based on a key performance indicator (KPI) metric, KPI of compositor, render, application frames per second (FPS), system user interface (UI), display FPS, motion to photon (M2P), motion to render to photon (M2R2P), photon to photon (P2P) or any other KPI.

One or more of the KPIs may be monitored over a certain hysteresis or window of time to determine if the boost may be skipped for the window of time. For example, if the monitored one or more KPIs meet a predefined acceptable threshold, for instance, with respect to user experience, quality and other XR metrics (M2P, M2R2P, P2P), then the boost may be skipped. In some aspects, the monitored KPI information may be provided via a feedback loop to provide a hint (e.g., a suggestion or indication) for the boost determination.

In some aspects the sliding window may indicate different frequency/voltage levels, cache profiles and any other performance/power knobs.

Accordingly, operation of the example architecture 600 may be conducted such that when an application (e.g., an XR application) requests a compute or render task to be performed by the GPU 104, an application programming interface (API) may create a GPU context. An API may facilitate use of the GPU 104 for performing compute or render tasks. That is, APIs may serve as a bridge between software applications and the GPU hardware 104. APIs may provide a set of functions or protocols that enable different applications to communicate with each other or to interact with the GPU 104 without requiring detailed knowledge of the underlying hardware.

The example architecture 600 may include one or more drivers such as a kernel mode driver (KMD) 610. The KMD 610 may manage the communication between the GPU hardware 104 and the operating system (OS). For example, when an application issues GPU-related commands through an API, the KMD 610 may translate the commands into instructions that the GPU 104 can understand. The KMD 610 instructions may be included in a GPU context. A GPU context may refer to a virtual space created for each task that is to be executed using the GPU 104. The GPU context may include current state of information such as data, variables, conditions, and other information that the GPU 104 may use to perform a computation for executing the task. GPU context commands may be inserted to a context command queue (ctxQ) 616 (shown as host firmware interface (HFI) ctxQ). An enhanced command processor (ECP) task dispatch 604 of the GMU 602 reads the context commands from the context command queue (ctxQ) 616 and schedules tasks of the GMU 602.

The ECP task dispatch 604 provides the GPU context commands to the workload boost manager 608. When the workload boost manager 608 receives an indication of an ATW workload such as (but not limited to) an ATW RT context 606, the workload boost manager 608 may adjust the clock frequency of the GPU 104 for the ATW workload based on a target warp latency or refresh rate (e.g., 90 Hz), for instance. In some aspects, the workload boost manager 608 may adjust the clock frequency of the GPU 104 within a sliding window of frequency levels. For example, the workload boost manager 608 may boost the GPU 104 clock frequency according to a sliding window determined based on a headroom performance KPI for other render workloads (e.g., GPU contexts in GPU ring buffers). Then, the workload boost manager 608 may configure the ATW RT context 606 in a ring buffer RB0 for the GPU 104. In some aspects, the workload boost manager 608 may detect a process identifier (ID), a thread ID, task filtering and/or a hint at the operating system (OS) firmware and may determine whether to boost the clock frequency of the GPU 104 or to skip boosting the clock frequency based on one or more of the KPIs.

In some aspects, the workload boost manager 608 may also adjust the clock frequency of the DDR 612. Furthermore, the workload boost manager 608 may adjust the CPU (e.g., 102) frequency, L1/L2 cache, LLC, and cache schemes employed and apply power control to the GPU 104 and the DDR 612 (e.g., using the always on power (AOP) resource management 614).

On the other hand, when an ATW workload indication (e.g., ATW RT context 606) has not been received by the workload boost manager 608, the workload boost manager 608 may determine not to adjust the GPU 104 clock frequency and/or DDR 612 clock frequency. Instead, the ECP task dispatch 604 may continue providing the following GPU contexts of the context queue 616 to the workload boost manager 608 and the GPU 104 for processing.

When the GPU 104 completes processing of the ATW RT context 606, the GPU 104 may send a work complete interrupt to the ECP task dispatch 604. The ECP task dispatch 604 may select a next GPU context from the context queue 616 for processing by the GPU 104. The workload boost manager 608 may adjust the clock frequency of the GPU 104 to a lower frequency based on dynamic clock voltage scaling(DCVS), dynamic voltage frequency scaling or equivalent workloads in the computing device in view of the KPIs. As such, aspects of the present disclosure may beneficially reduce ATW latency as well as power consumption relative to conventional techniques.

Although, the example of FIG. 6A illustrates boosting the clock frequency of the GPU 104 relative to an ATW workload, the present disclosure is not so limiting. Rather, the workload boost manager 608 may in a similar manner adapt the clock frequency of the GPU 104 relative to other workloads include time warp workloads, space warp workloads and compositor workloads, for example.

FIG. 6B is a block diagram illustrating an example architecture 650 for processing application tasks using GPU hardware, in accordance with various aspects of the present disclosure. Referring to FIG. 6B, the example architecture 650 may include a ring buffer manager 652, a set of priority context lists 656a-d, and GPU hardware (HW) 104. The ring buffer manager 652 may comprise a four-level ring buffer, for example. A ring buffer may be considered a data structure that uses a single fixed length array arranged as if connected end-to-end with two pointers, one pointer representing the head of a queue and the other pointer representing the tail of the queue. Elements may be added to the ring buffer at the tail of the ring buffer in a first in-first out manner, last in first out or other arrangements, for example.

The ring buffer manager 652 may include a set of ring buffers RB0-RB3. Each ring buffer RB0-RB3 may support a different context priority list (e.g., 656a-d). For example, the ring buffer RB0 may support real-time priority (e.g., a highest priority) GPU contexts (e.g., 654a-z), the ring buffer RB1 may support high priority (e.g., second highest priority) GPU contexts, the ring buffer RB2 may support medium priority (e.g., third highest priority) GPU contexts, and the ring buffer RB3 may support lowest priority GPU contexts. Although the example of FIG. 6B includes four ring buffers to support GPU contexts, any number of ring buffers may be employed according to design preference.

Applications operating on a device including the SoC 100, such as a smartphone or an XR device (e.g., smartglasses or HMD), for example, may request GPU (e.g., GPU 104 of FIG. 1) resources for computing tasks using an application programming interface (API). The applications may use an operating system (OS) as an interface to communicate with hardware components of the device (e.g., the components of the SoC 100). The OS may include APIs, which may create a GPU context (e.g., 654a-z) and may assign a priority for the GPU context (e.g., 654a-z). Each GPU context (e.g., 654a-z) with the same priority may be linked as a list (e.g., 656a-d). The GPU context commands included in each context list (e.g., 656a-d) may then be submitted to a corresponding ring buffer (e.g., RB0-RB3). Then, the commands of the respective GPU contexts (e.g., 654a-z) may be supplied from the respective ring buffers (e.g., RB0-RB3) to the GPU hardware 104 for execution according to the context priority.

In accordance with aspects of the present disclosure, the workload boost manager 608 may adapt the priority of a GPU context. For example, the workload boost manager 608 may configure the ATW RT context (e.g., 606 of FIG. 6A) during runtime for RB0 (656a ) based on a predefined KPI (e.g., ATW latency<1.5 ms) or other metric, for instance.

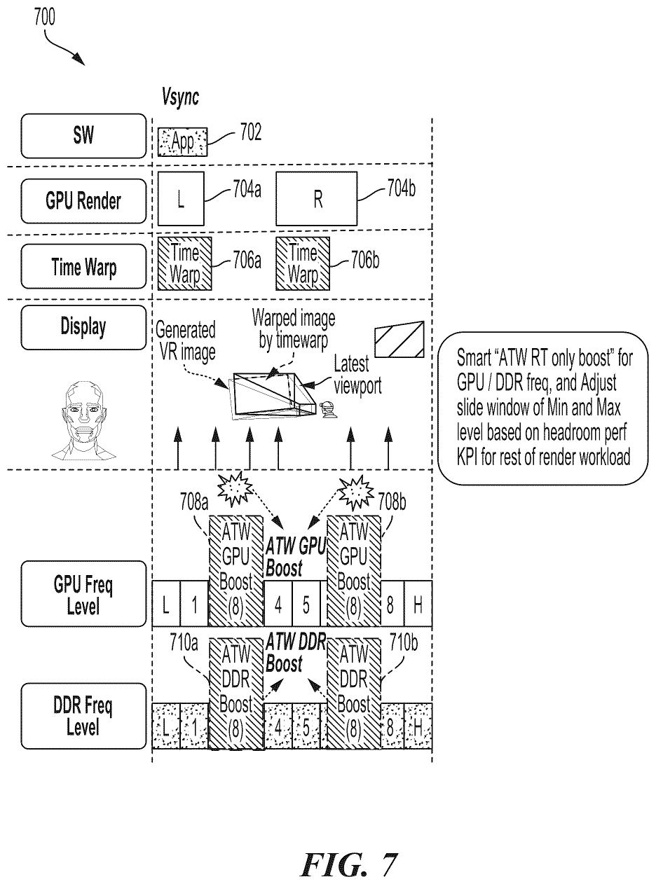

FIG. 7 is a diagram illustrating an example process 700 for dynamic frequency boosting for ATW workloads, in accordance with various aspects of the present disclosure. Referring to FIG. 7, a software application 702 may submit a left and a right rendering 704a, 704b. When a display of an XR device moves rapidly (e.g., user turns their head), the rendering by the GPU may be preempted and a reprojection of a prior rendering, referred to as a time warp (e.g., 706a, 706b), may be determined. Rather than applying dynamic clock and voltage scaling to adapt the GPU frequency as in conventional techniques, the GPU frequency may be boosted (e.g., 708a, 708b) when a time warp workload is indicated. In some aspects, the DDR frequency may also be adapted (e.g., 710a, 710b). The GPU frequency may be adjusted according to a sliding frequency window (e.g., 2-8) based on headroom performance KPI for the remainder of the render workload (e.g., GPU contexts in an active ring buffer (e.g., 656a-d of FIG. 6B). After the time warping (e.g., asynchronous time warp (ATW)) workload has been processed, the GPU frequency may be adjusted to a lowest frequency within the sliding window.

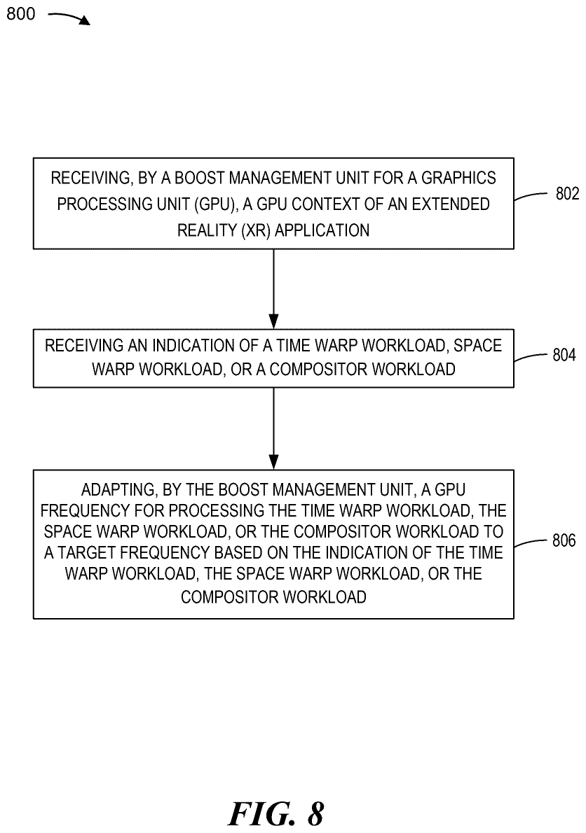

FIG. 8 is a flow diagram illustrating a method of dynamic frequency adjustment for ATW workloads, according to various aspects of the present disclosure. As shown in FIG. 8, at block 802, the process 800 receives, by a boost management unit for a graphics processing unit (GPU), a GPU context of an extended reality (XR) application. As described, for example, with reference to FIG. 6A, when an application issues GPU-related commands through an API, the KMD 610 may translate the commands into instructions that the GPU 104 can understand. The KMD 610 instructions may be included in a GPU context. GPU context commands may be inserted to a context command queue (ctxQ) 616 (shown as host firmware interface (HFI) ctxQ). An enhanced command processor (ECP) task dispatch 604 of the GMU 602 reads the context commands from the context command queue (ctxQ) 616 and schedules tasks of the GMU 602. In turn, the ECP task dispatch 604 provides the GPU context commands to the workload boost manager 608.

At block 804, the process 800 receives an indication of a time warp workload, space warp workload, or a compositor workload. For instance, as described with reference to FIG. 6A, the workload boost manager 608 may receive an indication of an ATW workload such as (but not limited to) an ATW RT context 606.

At block 806, the process 800 adapts, by the boost management unit, a GPU frequency for processing the time warp workload, the space warp workload, or the compositor workload to a target frequency based on the indication of the time warp workload, the space warp workload, or the compositor workload. As described, for example, with reference to FIG. 6A, when the workload boost manager 608 receives an ATW RT context 606, the workload boost manager 608 may adjust the clock frequency of the GPU 104 for the ATW workload based on a target warp latency or refresh rate (e.g., 90 Hz), for instance. In some aspects, the workload boost manager 608 may adjust the clock frequency of the GPU 104 within a sliding window of frequency levels. For example, the workload boost manager 608 may boost the GPU 104 clock frequency according to a sliding window determined based on a headroom performance KPI for other render workloads (e.g., GPU contexts in GPU ring buffers). In a similar manner, the workload boost manager 608 may adapt the clock frequency of the GPU 104 relative to other workloads include time warp workloads, space warp workloads and compositor workloads, for example.

In some aspects, the workload boost manager 608 may also adjust the clock frequency of the DDR 612. Furthermore, the workload boost manager 608 may adjust the CPU (e.g., 102) frequency, L1/L2 cache, LLC, and cache schemes employed and apply power control to the GPU 104 and the DDR 612 (e.g., using the always on power (AOP) resource management 614).

### EXAMPLE ASPECTS

Aspect 1: An apparatus, comprising: at least one memory; and at least one processor coupled to the at least one memory, the at least one processor configured to: receive, by a boost management unit for a graphics processing unit (GPU), a GPU context of an extended reality (XR) application; receive an indication of a time warp workload, space warp workload, or a compositor workload; and adapt, by the boost management unit, a GPU frequency for processing the time warp workload, the space warp workload, or the compositor workload to a target frequency based on the indication of the time warp workload, the space warp workload, or the compositor workload.

Aspect 2: The apparatus of Aspect 1, in which the at least one processor is further configured to submit the time warp workload to a first priority level for processing by the GPU.

Aspect 3: The apparatus of Aspect 1 or 2, in which the GPU frequency is adapted according to a sliding frequency window based on one or more key performance indicator (KPI) metrics.

Aspect 4: The apparatus of any preceding Aspect, in which the at least one processor is further configured to adapt one or more of a double data rate memory bus frequency, a central processing unit (CPU) frequency, a memory access priority, system resources for hardware priority change or software priority change, or manage a cache policy change.

Aspect 5: The apparatus of any preceding Aspect, in which the at least one processor is further configured to: increase the GPU frequency to the target frequency based on the indication; and decrease, in response to completing processing of the time warp workload, the space warp workload, or the compositor workload, the GPU frequency.

Aspect 6: The apparatus of any preceding Aspect, in which the at least one processor is further configured to adapt, by the boost management unit, a context identifier (ID) for each of one or more of the time warp workload, the space warp workload, or the compositor workload from high priority to real time (RT) priority.

Aspect 7: The apparatus of any preceding Aspect, in which the boost management unit is implemented in logic of graphics management unit (GMU) firmware associated with the GPU.

Aspect 8: A processor-implemented method performed by one or more processor, the processor-implemented method comprising: receiving, by a boost management unit for a graphics processing unit (GPU), a GPU context of an extended reality (XR) application; receiving an indication of a time warp workload, space warp workload, or a compositor workload; and adapting, by the boost management unit, a GPU frequency for processing the time warp workload, the space warp workload, or the compositor workload to a target frequency based on the indication of the time warp workload, the space warp workload, or the compositor workload.

Aspect 9: The processor-implemented method of Aspect 8, further comprising submitting the time warp workload to a first priority level for processing by the GPU.

Aspect 10: The processor-implemented method of Aspect 8 or 9, in which the GPU frequency is adapted according to a sliding frequency window based on one or more key performance indicator (KPI) metrics.

Aspect 11: The processor-implemented method of any of Aspects 8-10, further comprising adapting one or more of a double data rate memory bus frequency, a central processing unit (CPU) frequency, a memory access priority, system resources for hardware priority change or software priority change, or manage a cache policy change.

Aspect 12: The processor-implemented method of any of Aspects 8-111, further comprising: increasing the GPU frequency to the target frequency based on the indication; and decreasing, in response to completing processing of the time warp workload, the space warp workload, or the compositor workload, the GPU frequency.

Aspect 13: The processor-implemented method of any of Aspects 8-12, further comprising adapting, by the boost management unit, a context identifier (ID) for each of one or more of the time warp workload, the space warp workload, or the compositor workload from high priority to real time (RT) priority.

Aspect 14: The processor-implemented method of any of Aspects 8-13, in which the boost management unit is implemented in logic of graphics management unit (GMU) firmware associated with the GPU.

Aspect 15: An apparatus, comprising: means for receiving, by a boost management unit for a graphics processing unit (GPU), a GPU context of an extended reality (XR) application; means for receiving an indication of a time warp workload, space warp workload, or a compositor workload; and means for adapting, by the boost management unit, a GPU frequency for processing the time warp workload, the space warp workload, or the compositor workload to a target frequency based on the indication of the time warp workload, the space warp workload, or the compositor workload.

Aspect 16: The apparatus of Aspect 15, further comprising means for submitting the time warp workload to a first priority level for processing by the GPU.

Aspect 17: The apparatus of Aspects 15 or 16, in which the GPU frequency is adapted according to a sliding frequency window based on one or more key performance indicator (KPI) metrics.

Aspect 18: The apparatus of any of Aspects 15-17, further comprising means for adapting one or more of a double data rate memory bus frequency, a central processing unit (CPU) frequency, a memory access priority, system resources for hardware priority change or software priority change, or manage a cache policy change.

Aspect 19: The apparatus of any of Aspects 15-18, further comprising: means for increasing the GPU frequency to the target frequency based on the indication; and means for decreasing, in response to completing processing of the time warp workload, the space warp workload, or the compositor workload, the GPU frequency.

Aspect 20: The apparatus of any of Aspects 15-19, further comprising means for adapting, by the boost management unit, a context identifier (ID) for each of one or more of the time warp workload, the space warp workload, or the compositor workload from high priority to real time (RT) priority.

In one aspect, an apparatus includes means for receiving, by a boost management unit for a graphics processing unit (GPU), a GPU context of an extended reality (XR) application; means for receiving an indication of a time warp workload, space warp workload, or a compositor workload and means for adapting, by the boost management unit, a GPU frequency for processing the time warp workload, the space warp workload, or the compositor workload to a target frequency based on the indication of the time warp workload, the space warp workload, or the compositor workload. The means for receiving a GPU context, means for receiving an indication and/or adapting means may for example, be the CPU 102, GPU 104, memory 118 and/or PMIC 310 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

In accordance with this disclosure, the term “or” may be interrupted as “and/or” where context does not dictate otherwise. Additionally, while phrases such as “one or more” or “at least one” or the like may have been used for some features disclosed herein but not others; the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices, Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules or units are described in this disclosure to emphasize functional aspects of devices configured to perform the disclosed techniques, but do not necessarily require realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus, comprising:
at least one memory; and
at least one processor coupled to the at least one memory, the at least one processor configured to:
receive, by a boost management unit for a graphics processing unit (GPU), a GPU context of an extended reality (XR) application;
receive an indication of a time warp workload, space warp workload, or a compositor workload; and
adapt, by the boost management unit, a GPU frequency for processing the time warp workload, the space warp workload, or the compositor workload to a target frequency based on the indication of the time warp workload, the space warp workload, or the compositor workload.

2. The apparatus of claim 1, in which the at least one processor is further configured to submit the time warp workload to a first priority level for processing by the GPU.

3. The apparatus of claim 1, in which the GPU frequency is adapted according to a sliding frequency window based on one or more key performance indicator (KPI) metrics.

4. The apparatus of claim 1, in which the at least one processor is further configured to adapt one or more of a double data rate memory bus frequency, a central processing unit (CPU) frequency, a memory access priority, system resources for hardware priority change or software priority change, or manage a cache policy change.

5. The apparatus of claim 1, in which the at least one processor is further configured to:
increase the GPU frequency to the target frequency based on the indication; and
decrease, in response to completing processing of the time warp workload, the space warp workload, or the compositor workload, the GPU frequency.

6. The apparatus of claim 1, in which the at least one processor is further configured to adapt, by the boost management unit, a context identifier (ID) for each of one or more of the time warp workload, the space warp workload, or the compositor workload from high priority to real time (RT) priority.

7. The apparatus of claim 1, in which the boost management unit is implemented in logic of graphics management unit (GMU) firmware associated with the GPU.

8. A processor-implemented method performed by one or more processor, the processor-implemented method comprising:
receiving, by a boost management unit for a graphics processing unit (GPU), a GPU context of an extended reality (XR) application;
receiving an indication of a time warp workload, space warp workload, or a compositor workload; and
adapting, by the boost management unit, a GPU frequency for processing the time warp workload, the space warp workload, or the compositor workload to a target frequency based on the indication of the time warp workload, the space warp workload, or the compositor workload.

9. The processor-implemented method of claim 8, further comprising submitting the time warp workload to a first priority level for processing by the GPU.

10. The processor-implemented method of claim 8, in which the GPU frequency is adapted according to a sliding frequency window based on one or more key performance indicator (KPI) metrics.

11. The processor-implemented method of claim 8, further comprising adapting one or more of a double data rate memory bus frequency, a central processing unit (CPU) frequency, a memory access priority, system resources for hardware priority change or software priority change, or manage a cache policy change.

12. The processor-implemented method of claim 8, further comprising:
increasing the GPU frequency to the target frequency based on the indication; and
decreasing, in response to completing processing of the time warp workload, the space warp workload, or the compositor workload, the GPU frequency.

13. The processor-implemented method of claim 8, further comprising adapting, by the boost management unit, a context identifier (ID) for each of one or more of the time warp workload, the space warp workload, or the compositor workload from high priority to real time (RT) priority.

14. The processor-implemented method of claim 8, in which the boost management unit is implemented in logic of graphics management unit (GMU) firmware associated with the GPU.

15. An apparatus, comprising:
means for receiving, by a boost management unit for a graphics processing unit (GPU), a GPU context of an extended reality (XR) application;
means for receiving an indication of a time warp workload, space warp workload, or a compositor workload; and
means for adapting, by the boost management unit, a GPU frequency for processing the time warp workload, the space warp workload, or the compositor workload to a target frequency based on the indication of the time warp workload, the space warp workload, or the compositor workload.

16. The apparatus of claim 15, further comprising means for submitting the time warp workload to a first priority level for processing by the GPU.

17. The apparatus of claim 15, in which the GPU frequency is adapted according to a sliding frequency window based on one or more key performance indicator (KPI) metrics.

18. The apparatus of claim 15, further comprising means for adapting one or more of a double data rate memory bus frequency, a central processing unit (CPU) frequency, a memory access priority, system resources for hardware priority change or software priority change, or manage a cache policy change.

19. The apparatus of claim 15, further comprising:
means for increasing the GPU frequency to the target frequency based on the indication; and
means for decreasing, in response to completing processing of the time warp workload, the space warp workload, or the compositor workload, the GPU frequency.

20. The apparatus of claim 15, further comprising means for adapting, by the boost management unit, a context identifier (ID) for each of one or more of the time warp workload, the space warp workload, or the compositor workload from high priority to real time (RT) priority.
